(19) United States
(12) Patent Application Publication
(10) Pub. No.: US 2006/0054423 A1
(43) Pub. Date: Mar. 16, 2006

(54) Suspension apparatus for vehicle

(75) Inventor: Satoshi Murata, Nishikamo-gun (JP)

Correspondence Address: OLIFF & BERRIDGE, PLC, P.O. BOX 19928, ALEXANDRIA, VA, 22320, US

(73) Assignee: Toyota Jidosha Kabushiki Kaisha, Toyota-shi (JP)

(21) Appl. No.: 11/219,710

(22) Filed: Sep. 7, 2005

(30) Foreign Application Priority Data
Sep. 15, 2004 (JP) 2004-268020

(51) Int. Cl. B60T 1/06

(52) U.S. Cl. 188/18 A; 280/124.105

(57) ABSTRACT

A knuckle of a suspension apparatus includes first and second press-formed plate members, and a spacer disposed therebetween. The first and second plate members are welded together in a state in which rear end bent edges and lower end bent edges of respective lower walls of the first and second plate members abut each other, and front end bent edges and rear end bent edges of respective upper walls of the first and second plate members abut each other. Open ends having no bent edge are formed at the front ends of the lower walls. A disc brake is attached to the outer side surface of the lower wall of the first plate member to be located outside the open end of the first plate member, or is attached to the inner side surfaces of the lower walls of the first and second plate members to be located between the open ends of the first and second plate members.

### BACKGROUND OF THE INVENTION

1. Field of the Invention

The present invention relates to a suspension apparatus for a vehicle which includes a knuckle for supporting a wheel.

2. Description of the Related Art

As disclosed in, for example, Japanese Patent Application Laid-Open (kokai) No. H10-129225, there has conventionally been known a suspension apparatus for a vehicle in which a knuckle is constituted by two press-formed plate members. In the suspension apparatus, the plate members that constitute the knuckle are bent, by means of press forming, along the nearly entire portinos of their circumferences. As a result of bending, bent edges are formed on the two plate members such that the bent edges can overlap each other. The two plate members are fixed together by means of welding performed along the bent edges.

In general, a brake mechanism for braking a wheel is attached to the knuckle of such a suspension apparatus. However, if such a brake mechanism is attached to the knuckle of the above-described conventional suspension apparatus, various problems arise. That is, in the conventional suspension apparatus, two plate members are bent by means of press forming and welded along the nearly entire portions of their circumferences. Therefore, a mounting surface of the knuckle to which a brake mechanism is mounted is influenced by distortions stemming from bending and welding, so that the mounting surface has poor flatness. In the case where a brake mechanism is attached to the mounting surface of the knuckle having poor flatness, pads of the brake mechanism are not disposed in parallel to a disc rotor, so that the pads come into nonuniform contact with the disc rotor with resultant local wear of the pads, and creaking sound is generated during braking.

Moreover, the peripheral edge of the knuckle projects outward by at least a distance corresponding to the sum of the thickness of the plate member and the inner bending radius. Since the thickness of the plate member and the bending radius must be set to predetermined values or greater from the viewpoint of strength, in order to avoid interference between the knuckle and the brake mechanism, the space between the knuckle and the brake mechanism must be increased in order to secure a sufficient installation space for the brake mechanism. However, securing a sufficient installation space is difficult.

### SUMMARY OF THE INVENTION

The present invention has been accomplished to solve the above-described problems, and an object of the present invention is to provide a suspension apparatus for a vehicle that includes a knuckle in which a mounting surface to which a brake mechanism is mounted has a sufficient degree of flatness and which facilitates securing of sufficient installation space for the brake mechanism.

In order to achieve the above object, the present invention provides a suspension apparatus for a vehicle which comprises a knuckle which includes a plurality of plate members which are integrally fixed together at respective bent edges thereof which are bent for mutual abutment, which is interposed between a vehicle body and a wheel-side support member so as to support a wheel, and to which a brake mechanism for braking the wheel is mounted. The knuckle has an open end extending over a predetermined range, the open end being formed as a result of fixing the plurality of plate members together, and having no bent edge formed through bending. The brake mechanism is mounted onto an outer side surface or inner side surface of the open end. In this case, preferably, a reinforcement member having a thickness substantially equal to a clearance between the plate members is inserted between the plate members. Preferably, the reinforcement member has a through-hole having a stepped portion, and an annular groove is formed in the stepped portion such that the annular groove opens in a direction of the axis of the through-hole.

No bent edge is formed at the open end of the knuckle. Therefore, the outer side surface and inner side surface of the open end are less likely to be influenced by distortions stemming from bending and welding, and can have a high degree of flatness. The open end of the knuckle does not project outward by bent edges, so that a space corresponding to the reduction in projection can be used as a part of installation space for the brake mechanism.

### BRIEF DESCRIPTION OF THE DRAWINGS

Various other objects, features and many of the attendant advantages of the present invention will be readily appreciated as the same becomes better understood by reference to the following detailed description of the preferred embodiment when considered in connection with the accompanying drawings, in which:

FIG. 1 is a perspective view of a suspension apparatus for a vehicle according to an embodiment of the present invention;

FIG. 2A is a perspective view of a knuckle according to the embodiment;

FIG. 2B is a perspective view of a spacer which partially constitutes the knuckle shown in FIG. 2A;

FIG. 3 is an exploded perspective view of the knuckle shown in FIG. 2A;

FIG. 4 is an exploded perspective view showing the assembling positions of the knuckle shown in FIG. 2A and a bearing unit and a drive shaft to be assembled to the knuckle;

FIG. 5 is a cross sectional view taken along line 5-5 of FIG. 6;

FIG. 6 is a front view showing a state in which a disc brake has been assembled to the knuckle shown in FIG. 2A;

FIG. 7 is a cross sectional view taken along line 7-7 of FIG. 6;

FIG. 8 is a perspective view of the knuckle as viewed from the rear in FIG. 6;

FIG. 9 is an exploded perspective view showing the assembling positions of a knuckle according to a modification of the embodiment and a bearing unit and a drive shaft to be assembled to the knuckle; and

FIG. 10 is a side sectional view showing a state in which the knuckle, the bearing unit, and the drive shaft, all shown in FIG. 9, have been assembled together.

### DESCRIPTION OF THE PREFERRED EMBODIMENT

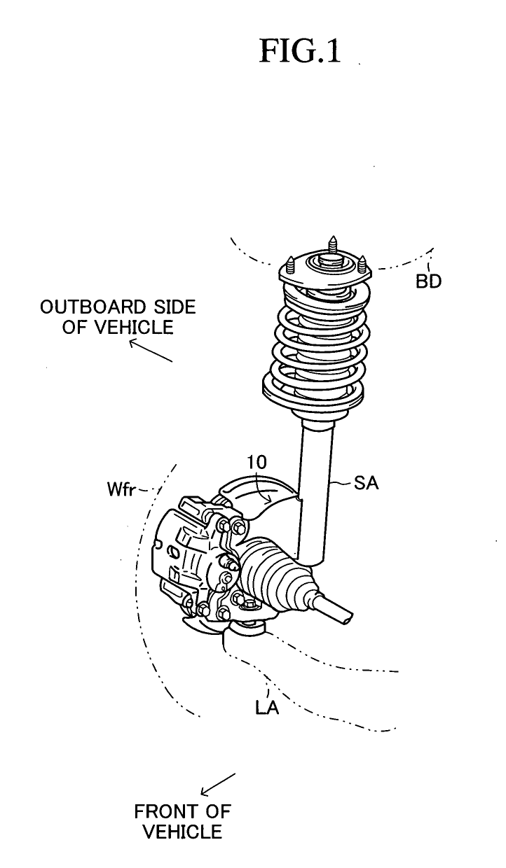

An embodiment of the present invention will now be described with reference to the drawings. FIG. 1 is an overall schematic view of a strut-type suspension apparatus which is a suspension apparatus for a vehicle according to the embodiment. FIG. 1 shows only a suspension apparatus for a front right wheel Wfr, which is a driven wheel, as a representative. The suspension apparatus includes a knuckle 10. The knuckle 10 is interposed between a shock absorber SA, which supports a vehicle body BD, and a lower arm LA, which is a wheel-side support member. The knuckle 10 supports the front right wheel Wfr such that the front right wheel Wfr can be steered and rotated.

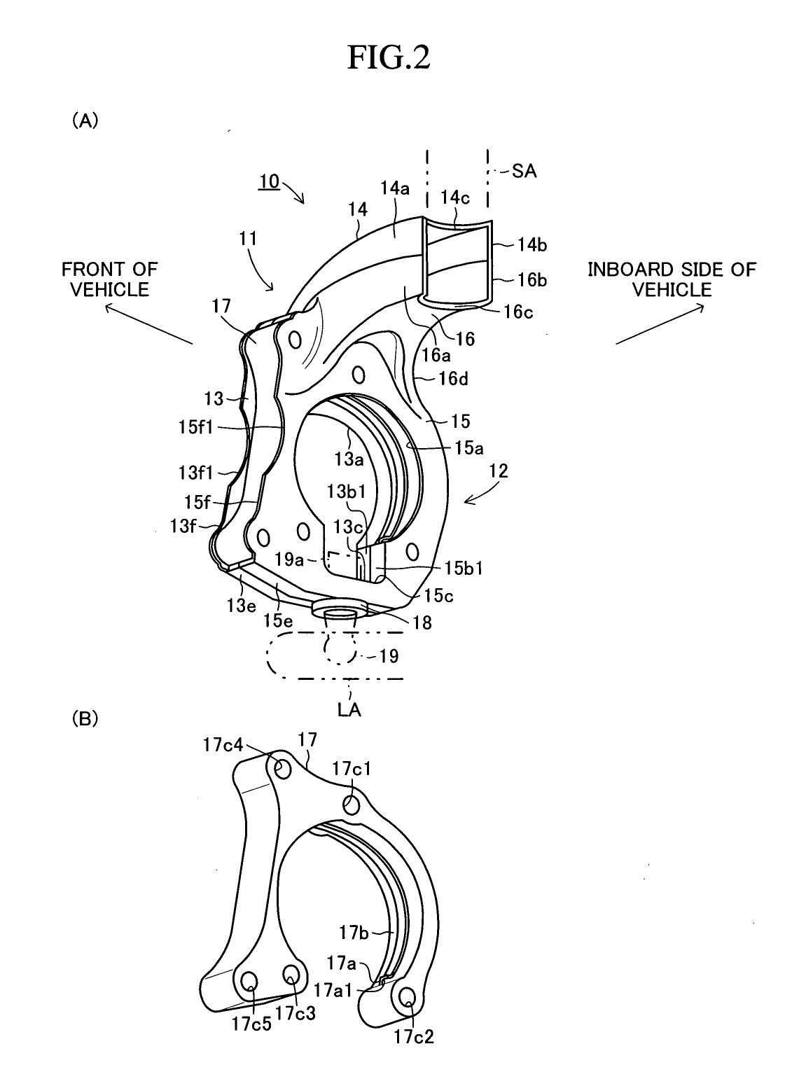

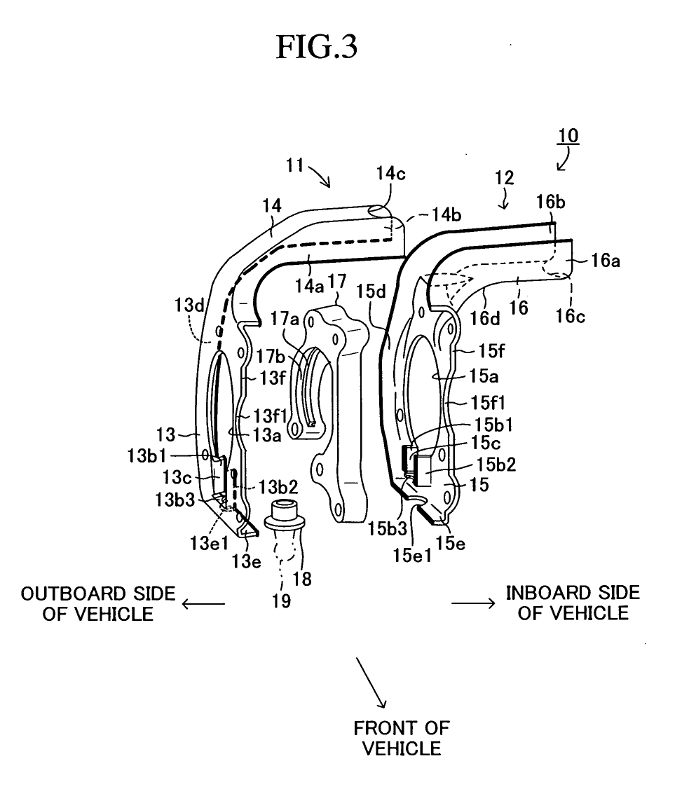

As shown in FIGS. 2A and 3, the knuckle 10 includes two plate members 11 and 12 each press-formed into a generally L-like shape as viewed from the front of the vehicle. Predetermined corresponding portions of the circumferential edges of the plate members 11 and 12 are bent such that the corresponding portions abut each other and are welded together along abuttal lines indicated by thick solid lines and thick broken lines in FIG. 3.

First, the plate member 11 will be described. The plate member 11 is located on the outboard side, and has a lower wall 13, which extends vertically, and an upper wall 14, which extends from the upper end of the lower wall 13 while curving inboard and then extends horizontally. The lower wall 13 is flat and assumes a generally D-like shape as viewed from the inboard side.

A circular through-hole 13a is formed in a central portion of the lower wall 13, and a rectangular recess 13c extending downward from the through-hole 13a is formed by three tabs 13b1, 13b2, and 13b3, which are bent inboard. A rear end bent edge 13d and a lower end bent edge 13e are formed integrally and continuously with the lower wall 13. The rear end bent edge 13d and the lower end bent edge 13e have the same bending allowance, and are each bent inboard at a right angle and with a predetermined bending radius. A semicircular cut 13e1 is formed in an intermediate portion of the lower end bent edge 13e.

The upper wall 14 is formed to have a width roughly equal to the outer diameter of the shock absorber SA. A front end bent edge 14a and a rear end bent edge 14b are formed integrally and continuously with the upper wall 14. The front end bent edge 14a and the rear end bent edge 14b have generally symmetrical configurations, and are each bent downward at a right angle and with a predetermined bending radius. The upper wall 14, together with the front end bent edge 14a and the rear end bent edge 14b, forms a generally inverted-U-like shape as viewed from the inboard side.

A semicircular cut 14c is formed in the inboard end of the upper wall 14. The shock absorber SA is accommodated in the semicircular cut 14c and between the front end bent edge 14a and the rear end bent edge 14b, and is brought into contact with and welded to the bottom edge of the cut 14c, the front end bent edge 14a, and the rear end bent edge 14b.

The rear end bent edge 14b of the upper wall 14 curves downward while reducing its bending allowance and connecting to the rear end bent edge 13d of the lower wall 13. Meanwhile, the front end bent edge 14a of the upper wall 14 curves downward while extending toward the front of the vehicle to thereby form a bent edge perpendicular to the lower wall 13, and connect with the front end surface of the lower wall 13 at the upper end of the lower wall 13.

No bent edge is formed on the front end of the lower wall 13. Thus, an open end 13f is formed by the respective front ends of the lower wall 13, the lower end bent edge 13e of the lower wall 13, and the front end bent edge 14a of the upper wall 14. An arcuate cut 13f1 is formed in an intermediate portion of the open end 13f.

Next, the plate member 12 will be described. The plate member 12 is located on the inboard side, and, similar to the plate member 11, has a lower wall 15, which extends vertically, and an upper wall 16, which extends from the upper end of the lower wall 15 while curving inboard and then extends horizontally. The lower wall 15 is flat and assumes a generally D-like shape as viewed from the inboard side, the shape corresponding to that of the lower wall 13 of the plate member 11.

A circular through-hole 15a is formed in a central portion of the lower wall 15 coaxially with the through-hole 13a of the lower wall 13 such that the through-hole 15a is slightly greater in diameter than the through-hole 13a. Further, a rectangular recess 15c extending downward from the through-hole 15a is formed by three tabs 15b1, 15b2, and 15b3, which are bent outboard. These tabs 15b1, 15b2, and 15b3 are brought into contact with the tabs 13b1, 13b2, and 13b3 of the lower wall 13 and welded together along respective abuttal lines. By virtue of formation of the recesses 13c and 15c, an opening extends through the lower walls 13 and 15 parallel to the axes of the through-holes 13a and 15a.

A rear end bent edge 15d and a lower end bent edge 15e are formed integrally and continuously with the lower wall 15. The rear end bent edge 15d and the lower end bent edge 15e have the same bending allowance, and are each bent outboard at a right angle and with a predetermined bending radius. A semicircular cut 15e1 is formed in an intermediate portion of the lower end bent edge 15e.

The upper wall 16 is formed to have a width roughly equal to the outer diameter of the shock absorber SA. A front end bent edge 16a and a rear end bent edge 16b are formed integrally and continuously with the upper wall 16. The front end bent edge 16a and the rear end bent edge 16b have generally symmetrical configurations, and are each bent upward at a right angle and with a predetermined bending radius. The upper wall 16, together with the front end bent edge 16a and the rear end bent edge 16b, forms a generally U-like shape as viewed from the inboard side.

A semicircular cut 16c is formed in the inboard end of the upper wall 16. The shock absorber SA is accommodated in the semicircular cut 16c and between the front end bent edge 16a and the rear end bent edge 16b. The shock absorber SA is welded to the second plate member 12 along respective abuttal lines of the cut 16c, the front end bent edge 16a, and the rear end bent edge 16b thereof, as well as to the first plate member 11 along respective abuttal lines of the cut 14c, the front end bent edge 14a, and the rear end bent edge 14b thereof. A projecting portion 16d is formed at the outboard end of the upper wall 16 such that the projecting portion 16d is forked and projects downward. The projecting portion 16d connects to the upper end of the lower wall 15 while curving, to thereby reinforce the upper wall 16.

The rear end bent edge 16b of the upper wall 16 curves downward while reducing its bending allowance and connecting to the rear end bent edge 15d of the lower wall 15. Meanwhile, the front end bent edge 16a of the upper wall 16 curves downward while extending toward the front of the vehicle to thereby form a bent edge perpendicular to the lower wall 15, and connect with the front end surface of the lower wall 15 at the upper end of the lower wall 15.

Like the case of front end of the lower wall 13, no bent edge is formed on the front end of the lower wall 15. Thus, an open end 15f is formed by the respective front ends of the lower wall 15, the lower end bent edge 15e of the lower wall 15, and the front end bent edge 16a of the upper wall 16. The open end 15f, in cooperation with the open end 13f of the lower wall 13, forms an open end of the knuckle 10. An arcuate cut 15f1 which is roughly the same size as the arcuate cut 13f1 of the open end 13f is formed in an intermeidate portion of the open end 15f in alignment with the arcuate cut 13f1.

In addition to the above-described plate members 11 and 12, the knuckle 10 includes a spacer 17 and a ball joint attachment member 18, which are interposed between the plate members 11 and 12. The spacer 17 serves as a reinforcement member for reinforcing the plate members 11 and 12. As shown in FIG. 2B, the spacer 17 is a member which assumes a generally D-like shape, and whose bottom portion is partially removed to be open. The spacer 17 is formed from a metal material such as aluminum through extrusion such that it has a thickness roughly equal to the clearance between the plate members 11 and 12. A circular through-hole 17b having a stepped portion 17a is formed in the spacer 17. The stepped portion 17a has an inner diameter smaller than the inner diameter of the through-holes 13a and 15a of the plate members 11 and 12, and has an annular groove 17a1 opened to the inboard side. The annular groove 17a1 will be described later.

Referring back to FIG. 3, the ball joint attachment member 18 is used to attach a ball joint 19 to the knuckle 10. The ball joint attachment member 18 assumes the form of a stepped cylindrical tube. The ball joint attachment member 18 is disposed between the cut 13e1 of the lower end bent edge 13e of the plate 11 and the cut 15e1 of the lower end bent edge 15e of the plate 12 and between the tab 13b3 parallel to the lower end bent edge 13e and the tab 15b3 parallel to the lower end bent edge 15e. In this state, the ball joint attachment member 18 is welded to the plate members 11 and 12 along respective abuttal lines. The ball joint 19 penetrates the ball joint attachment member 18, and is fixed by means of a nut 19a disposed within the recesses 13c and 15c (see FIG. 2A).

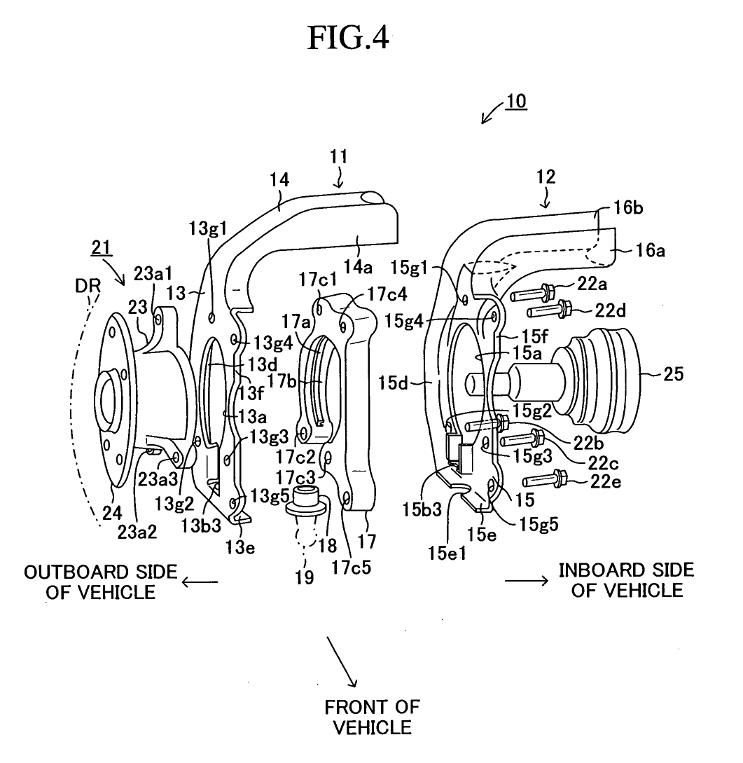

As shown in FIG. 4, a bearing unit 21 is attached to the outer side surface of the lower wall 13 of the first plate member 11. The bearing unit 21 includes a bearing body 23, which is attached to the outer side surface of the lower wall 13 via three bolts 22a, 22b, and 22c, and a hub 24 rotatably supported by the bearing body 23.

The bolts 22a, 22b, and 22c pass through through-holes 15g1, 15g2, and 15g3 formed in the lower wall 15 of the plate member 12, through-holes 17c1, 17c2, and 17c3 formed in the spacer 17, and through-holes 13g1, 13g2, and 13g3 formed in the lower wall 13 of the plate member 11, and are in screw engagement with nut portions 23a1, 23a2, and 23a3 formed in the bearing body 23. Thus, the bearing body 23 is fixed to the outer side surface of the lower wall 13.

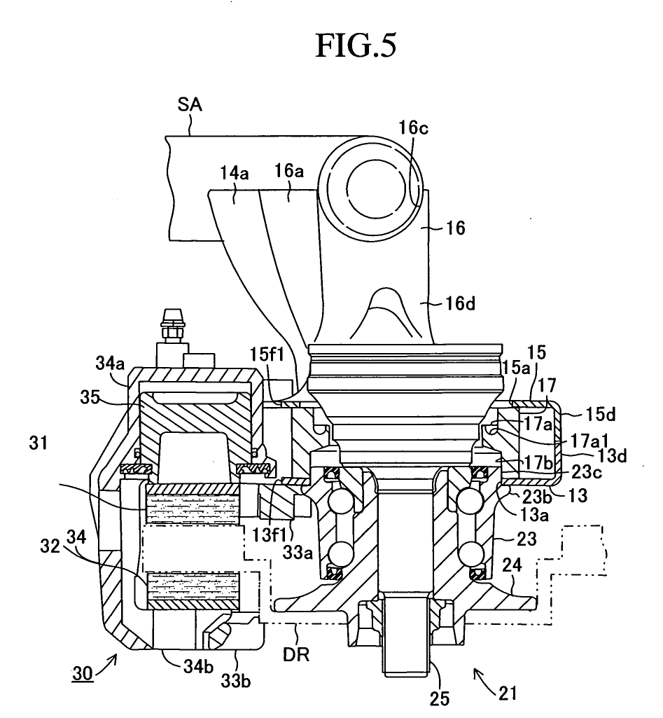

As shown in FIG. 5, the bearing body 23 assumes the form of a cylindrical tube having a circular stepped portion 23b. An inside cylindrical end 23c of the bearing body 23 has an outer diameter roughly equal to the inner diameter of the through-hole 13a of the plate member 11 and the through-hole 17b of the spacer 17. In a state in which the bearing body 23 is attached to the outer side surface of the lower wall 13, the inner circumferential surface of the stepped portion 23b comes into contact with the outer side surface of the lower wall 13, and the inside cylindrical end 23c passes through the through-hole 13a of the plate member 11, and fits into the through-hole 17b of the spacer 17. Thus, the spacer 17 is radially positioned, so that the axis of the through-hole 17b of the spacer 17 coincides with the axis of the hub 24.

One axial end of a drive shaft 25, which is fitted into the hub 24 from the inboard side of the vehicle, is fixed to the hub 24 for unitary rotation. An unillustrated disc wheel, a disc rotor DR, etc. are integrally attached to the hub 24 via unillustrated bolts. Thus, with rotation of the drive shaft 25, the hub 24 and the disc rotor DR rotate unitarily.

In a state in which the drive shaft 25 is fixed to the hub 24, a very small clearance is formed between the drive shaft 25 and the stepped portion 17a of the spacer 17. Further, as described above, the stepped portion 17a has an annular groove 17a1 opened toward the inboard side. The annular groove 17a1, in cooperation with the very small clearance, prevents entry, into the bearing body 23, of foreign substances, such as dust and mud, which have entered from the inner side of the vehicle into the knuckle 10 via the through-hole 15a of the lower wall 15 of the plate member 12.

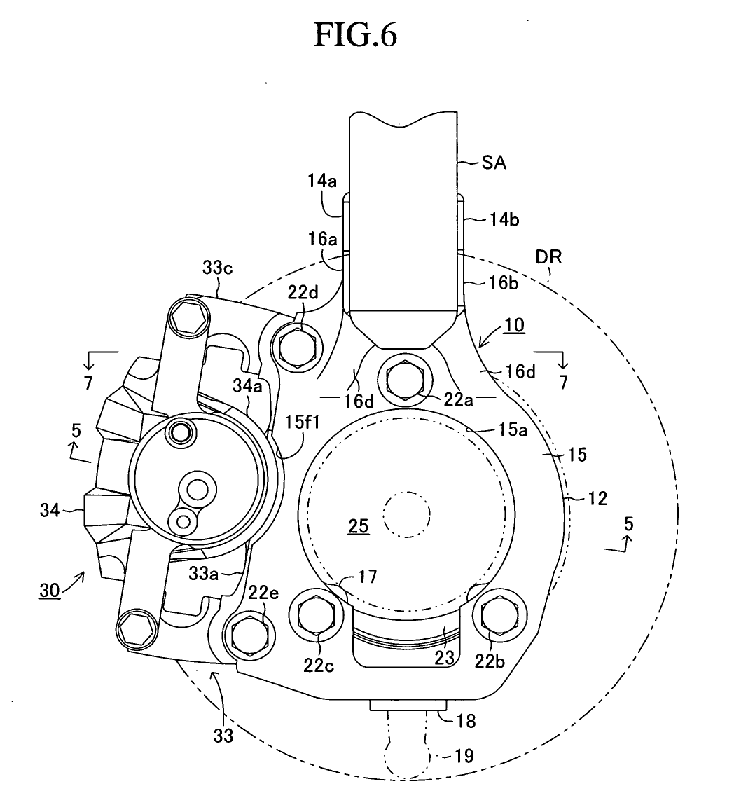

A disc brake 30, which serves as a brake mechanism, is attached to the outer side surface of the lower wall 13 of the plate member 11. As shown in FIGS. 5 and 6, the disc brake 30 is of a known type, and is configured such that an inner pad 31 and an outer pad 32 for braking the disc rotor DR are mounted to a mounting 33 to be movable along the direction of the rotor axis. In this disc brake 30, a movable caliper 34 is mounted to the mounting 33 to be movable along the direction of the rotor axis.

The inner pad 31 moves toward the disc rotor DR when it is pushed by means of a piston 35, which is received in a cylinder portion 34a of the movable caliper 34 to be movable along the direction of the rotor axis. The outer pad 32 moves toward the disc rotor DR when it is pushed by means of a nail portion 34b of the movable caliper 34, which is formed to straddle the disc rotor DR.

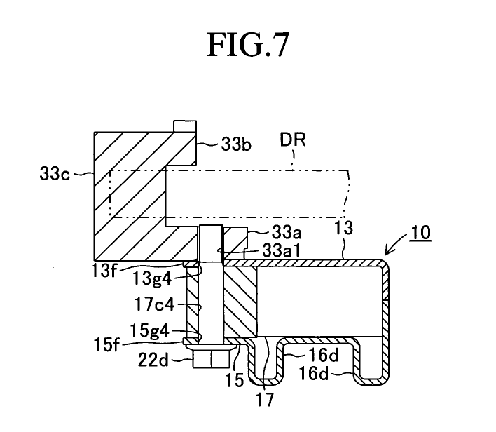

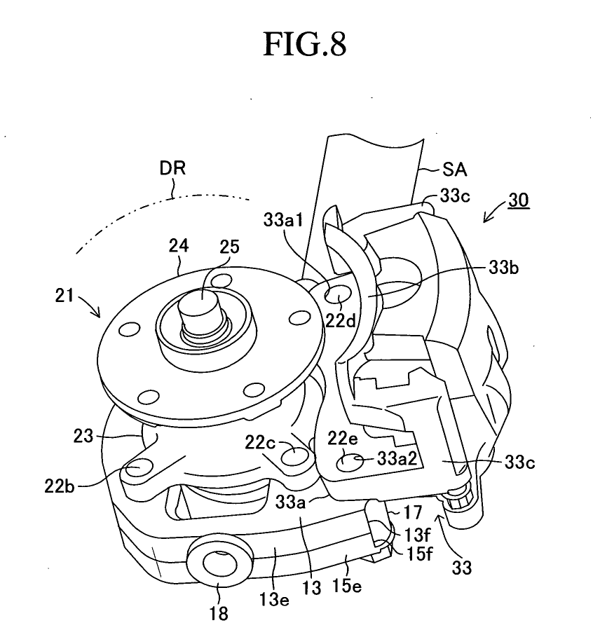

As shown in FIGS. 7 and 8, the mounting 33 includes an elongated attachment portion 33a facing the inner side of the disc rotor DR and having a rectangular cross section, a connection portion 33b facing the outer side of the disc rotor DR and having a rectangular cross section, and generally U-shaped arms 33c formed to straddle the disc rotor DR and connecting the opposite ends of the attachment portion 33a with the opposite ends of the connection portion 33b, respectively. The attachment portion 33a is disposed in the vicinity of the front end of the lower wall 13; i.e., on the outer side surface of the open end 13f such that the attachment portion 33a extends from the upper end to the lower end of the lower wall 13. The inner side surface of the attachment portion 33a, which faces the lower wall 13, is formed to be flat, and nut portions 33a1 and 33a2 are formed in opposite end portions of the attachment portion 33a. The attachment portion 33a is attached to the lower wall 13 by use of bolts 22d and 22e.

The bolts 22d and 22e pass through through-holes 15g4 and 15g5 formed in the lower wall 15 of the plate member 12, through-holes 17c4 and 17c5 formed in the spacer 17, and through-holes 13g4 and 13g5 formed in the lower wall 13 of the plate member 11 (see FIG. 4), and are in screw engagement with the nut portions 33a1 and 33a2 formed in the attachment portion 33a. Thus, the attachment portion 33a is fixed to the lower wall 13.

According to the present embodiment configured as described above, no bent edge is formed at the open end 13f of the first plate member 11 and the open end 15f of the second plate member 12, which form the open end of the knuckle 10. Therefore, the outer side surface of the open end 13f of the plate member 11, to which the attachment portion 33a of the mounting 33 is attached, is less likely to be influenced by distortions stemming from bending and welding, and can have a high degree of flatness. As a result, the inner pad 31 and the outer pad 32 are disposed in parallel to the disc rotor DR, so that the pads 31 and 32 are prevented from coming into nonuniform contact with the disc rotor DR. Therefore, the present embodiment can prevent local wear of the pads 31 and 32 and generation of creaking sound during braking operation of the disc brake 30.

Further, the open end 13f of the first plate member 11 and the open end 15f of the second plate member 12 project toward the front of the vehicle by a distance which is smaller than that in the case where bent edges are formed, by at least the sum of the thickness of the plate members 11 and 12 and the inner bending radius. Therefore, a space corresponding to the reduction in projection distance can be used as a part of installation space for the disc brake 30.

In particular, in the above-described embodiment, the cuts 13f1 and 15f1 are formed at the open ends 13f and 15f, respectively. This configuration, along with elimination of bent edges from the open ends 13d and 15f, enables the disc brake 30 to be attached closer to the open ends 13f and 15f by an amount corresponding to the depths of the cuts 13f1 and 15f1. Therefore, the space occupied by the disc brake 30 can be reduced.

In the above-described embodiment, the plate members 11 and 12 are welded together in a state in which the rear end bent edges 13d and 15d of the lower walls 13 and 15 abut each other and the lower end bent edges 13e and 15e of the lower walls 13 and 15 abut each other. Further, the plate members 11 and 12 are welded together in a state in which the front end bent edges 14a and 16a of the upper walls 14 and 16 abut each other and the rear end bent edges 14b and 16b of the upper walls 14 and 16 abut each other. Moreover, the spacer 17 is interposed between the plate members 11 and 12. This configuration enables the knuckle 10 to have a sufficient degree of rigidity.

In the above-described embodiment, the through-hole 17b having the stepped portion 17a is formed in the spacer 17. Therefore, as compared with the case where a stepped portion is formed on the plate members themselves through press forming without use of the spacer, the stepped portion 17a can be accurately formed to have a desired inner diameter. Moreover, the spacer 17 is radially positioned by means of the bearing body 23 such that the axis of the stepped portion 17a coincides with the axis of the drive shaft 25. Therefore, the clearance between the stepped portion 17a and the drive shaft 25 can be easily set to fall within a desired range. The clearance set in this manner, in cooperation with the annular groove 17a1 formed in the stepped portion 17a, provides an excellent effect of preventing entry of dust (labyrinth effect). This ensures proper operation of the bearing body 23, a sensor (not shown) for detecting rotation of the drive shaft 25, the disc brake 30, etc.

Next, a modification of the suspension apparatus according to the above-described embodiment will be described. In the modification to be described below, portions which are identical with those of the above-described embodiment are denoted by the same reference numerals, and their detailed descriptions are omitted.

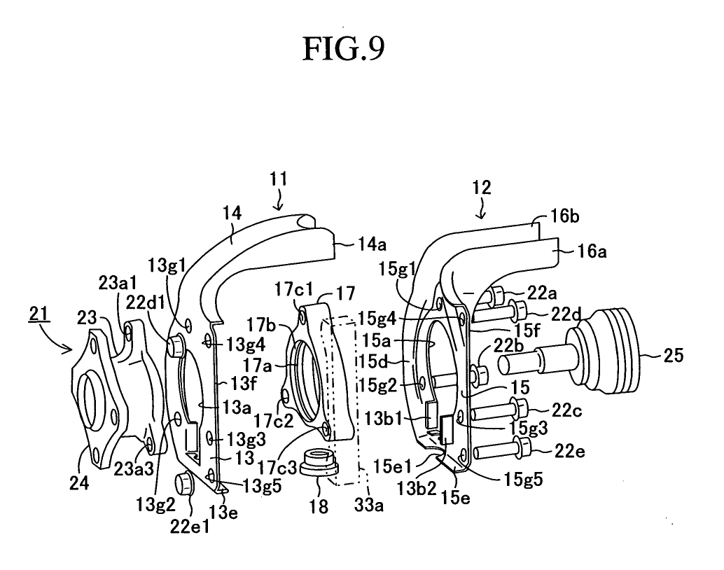

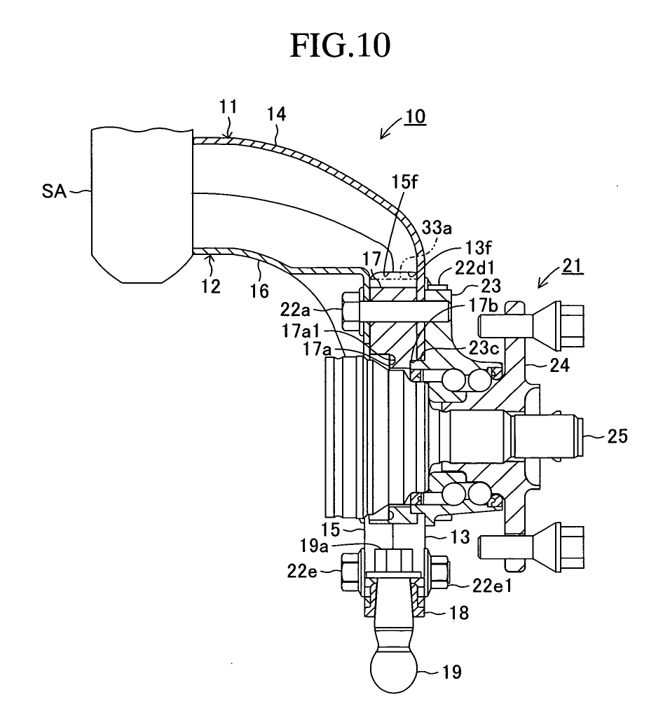

In the suspension apparatus according to the modification, as shown in FIGS. 9 and 10, the attachment portion 33a of the mounting 33 is disposed between the open end 13f of the first plate member 11 and the open end 15f of the second plate member 12, which form the open end of the knuckle 10, and is attached to the inner side surfaces of the open ends 13f and 15f by use of bolts 22d and 22e and nuts 22d1 and 22e1. Notably, in FIGS. 9 and 10, of members which constitute the disc brake 30, only the attachment portion 33a of the mounting 33 is schematically shown.

As in the case of the outer side surfaces of the open ends 13f and 15f, the inner side surfaces of the open ends 13f and 15f are less likely to be influenced by distortions stemming from bending and welding, and can have a high degree of flatness. Therefore, through attachment of the attachment portion 33a of the mounting 33 to the inner side surfaces, as in the case of the above-described embodiment, there can be attained the effect of preventing local wear of the pads 31 and 32 and generation of creaking sound during braking operation of the disc brake 30.

Further, in the present modification, the spacer 17 is formed of a generally triangular member, and the stepped portion 17a of the through-hole 17b is formed to have a continuous annular shape. In a state in which the bearing body 23 is attached to the outer side surface of the lower wall 13, the inside cylindrical end 23c fits into the through-hole 17b of the spacer 17 and comes into contact with the stepped portion 17a, whereby the spacer 17 is positioned in the radial and axial directions. Therefore, as in the above-described embodiment, the clearance between the stepped portion 17a and the drive shaft 25 can be easily set to fall within a desired range, whereby the effect of preventing entry of dust can be attained.

Unlike the above-described embodiment, the present modification employs a knuckle in which no cut is formed at the open ends 13f and 15f. However, the present modification may employ a knuckle 10 similar to that used in the above-described embodiment and in which cuts 13f1 and 15f1 are formed at the open ends 13f and 15f.

In the above, one embodiment of the present invention and its modification have been described. However, the present invention is not limited to the embodiment and modification and may be practiced in various modified forms without departing from the scope of the present invention.

In the above-described embodiment and modification, the present invention is applied to a strut-type suspension apparatus. In this case, since the upper walls 14 and 16 of the plate members 11 and 12 are directly welded to the shock absorber SA, components for attachment, such as bolts, nuts, and brackets, become unnecessary, and thus, weight and cost can be effectively reduced. However, the present invention can be applied to, for example, a double-wishbone-type suspension apparatus.

In the above-described embodiment and modification, a member formed through extrusion is used as the spacer 17. In this case, the shape of the spacer 17 is not limited to those described above, and the spacer 17 may assume any of various shapes. Moreover, in addition to, or in place of the spacer 17, a plurality of collars may be disposed between the plate members such that bolts pass through the collars. This configuration also enables the knuckle to have a sufficient degree of rigidity. Further, the present invention can be applied not only to suspension apparatuses for driven wheels, but also to suspension apparatuses for non-driven wheels.

What is claimed is:

1. A suspension apparatus for a vehicle which comprises a knuckle which includes a plurality of plate members which are integrally fixed together at respective bent edges thereof which are bent for mutual abutment, which is interposed between a vehicle body and a wheel-side support member so as to support a wheel, and to which a brake mechanism for braking the wheel is mounted, wherein
the knuckle has an open end extending over a predetermined range, the open end being formed as a result of fixing the plurality of plate members together, and having no bent edge formed through bending, and
the brake mechanism is mounted onto an outer side surface or inner side surface of the open end.

2. A suspension apparatus for a vehicle according to claim 1, wherein a reinforcement member having a thickness substantially equal to a clearance between the plate members is inserted between the plate members.

3. A suspension apparatus for a vehicle according to claim 2, wherein the plate members have a through-hole respectively, the reinforcement member has a through-hole having a stepped portion, and an annular groove is formed in the stepped portion such that the annular groove opens toward the inboard side of the vehicle.

4. A suspension apparatus for a vehicle according to claim 3, wherein a drive shaft is passed through through-holes formed in the plate members and the reinforcement from the inboard side of the vehicle, and a predetermined clearance is formed between the stepped portion of the reinforcement member and the drive shaft.
